(19) United States
(12) Patent Application Publication
(10) Pub. No.: US 2015/0349604 A1
(43) Pub. Date: Dec. 3, 2015

(54) SIDE-MOUNTED INTEGRATED MOTOR CONDUIT AND INTERFACE BOX

(71) Applicant: Nidec Motor Corporation, St. Louis, MO (US)

(72) Inventor: Craig E. Wallace, Brighton, IL (US)

(73) Assignee: Nidec Motor Corporation, St. Louis, MO (US)

(21) Appl. No.: 14/290,417

(22) Filed: May 29, 2014

(51) Int. Cl. H02K 5/22; H02K 11/00

(52) U.S. Cl. CPC H02K 5/225; H02K 11/0073; H02K 11/0094

(57) ABSTRACT

An electric motor is provided. The motor includes a stator and a rotor. The rotor is rotatable about an axis. The motor has a motor case fixed relative to the stator. An integrated conduit and interface box houses a power terminal and a user interface. The user interface is operable to permit a user to selectively vary a motor condition. The box is positioned substantially radially outside the motor case.

### BACKGROUND OF THE INVENTION

1. Field of the Invention

The present invention relates generally to electric motors. More specifically, the present invention concerns a motor assembly having an integrated conduit and interface box.

2. Discussion of Prior Art

Those of ordinarily skilled in the art will appreciate that in various applications, motors may be required to operate at variable speeds. Variable speed motors are used in a variety of applications, including, but not limited to, air moving products and pump applications. Variable speed motors are generally controlled using speed controllers. Speed controllers are typically found at an axial end of the motor.

### SUMMARY OF THE INVENTION

According to one aspect of the present invention, a motor assembly is provided. The motor assembly comprises dynamoelectric components, a motor case, a power terminal, a user interface, and an integrated conduit and interface box. The dynamoelectric components include a stator and a rotor. The rotor is located generally within the stator and is rotatable relative to the stator about an axis. The motor case is fixed relative to the stator and is spaced radially about the rotor axis. The power terminal is connectable to an input power conduit. The user interface is operable to permit a user to selectively vary a motor condition. The integrated conduit and interface box is positioned at least substantially radially outside the motor case. The box includes a power compartment in which the power terminal is located, and an electronics compartment in which the user interface is located. The compartments are separated and axially spaced from one another.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a front perspective view of a motor assembly constructed in accordance with a preferred embodiment of the present invention;

FIG. 2 is an exploded rear perspective view of the motor assembly of FIG. 1, with the interface lid to the integrated conduit and interface box being removed;

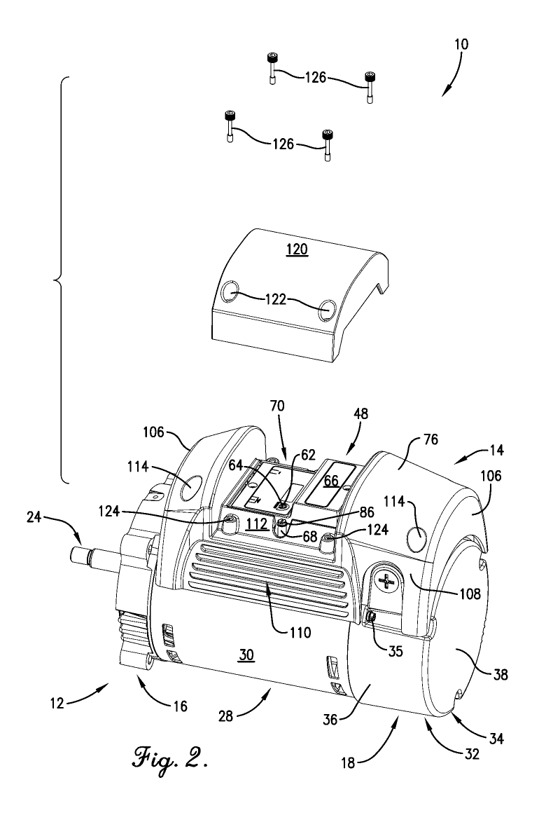

FIG. 3 is an exploded rear perspective view of the motor assembly of FIGS. 1-2, with the interface lid (not shown) and cover to the integrated conduit and interface box being removed;

FIG. 4 is a an exploded front perspective view of the motor assembly of FIGS. 1-3, with the integrated conduit and interface box and motor controller housing removed and the cover of the box not shown;

FIG. 5 is a top plan view of the motor assembly of FIGS. 1-4, with the cover to the integrated conduit and interface box removed;

FIG. 6 is an enlarged cross-sectional view of the motor assembly taken along line 6-6 of FIG. 5;

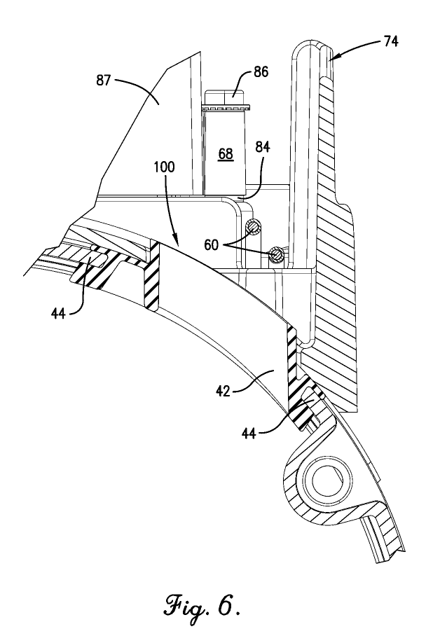

FIG. 7 is an enlarged cross-sectional view of the motor assembly taken along line 7-7 of FIG. 5; and

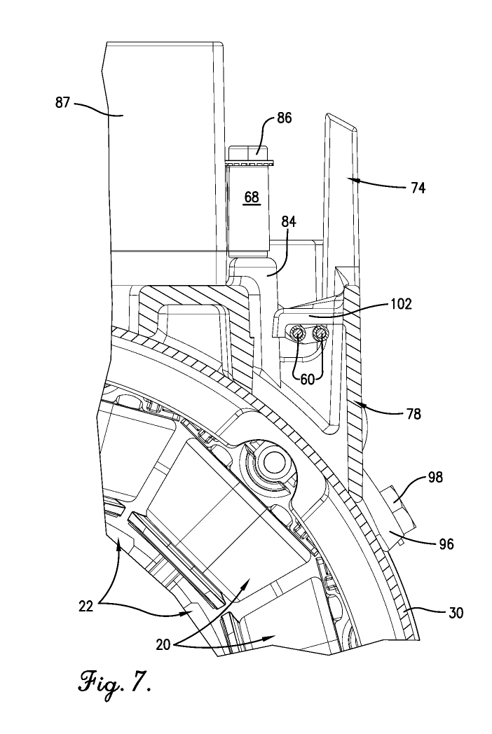

FIG. 8 is a fragmented front perspective view of the motor assembly of FIGS. 1-5, with most of the motor being removed to depict the wiring extending through the connection block opening.

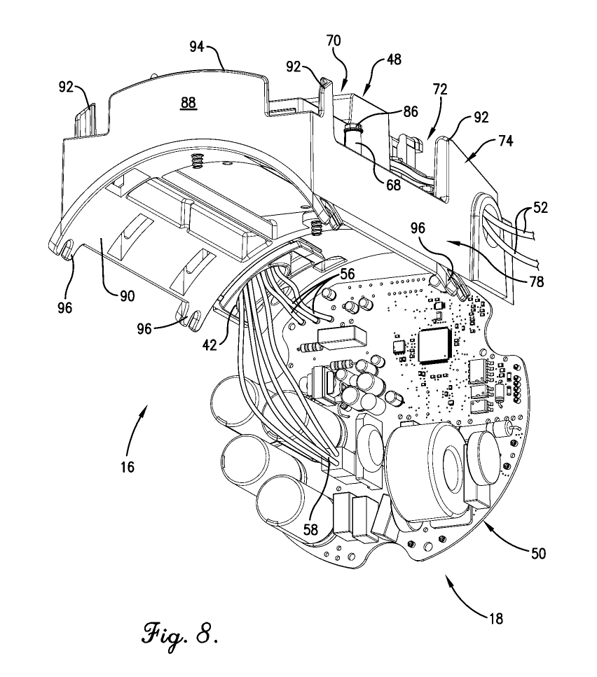

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

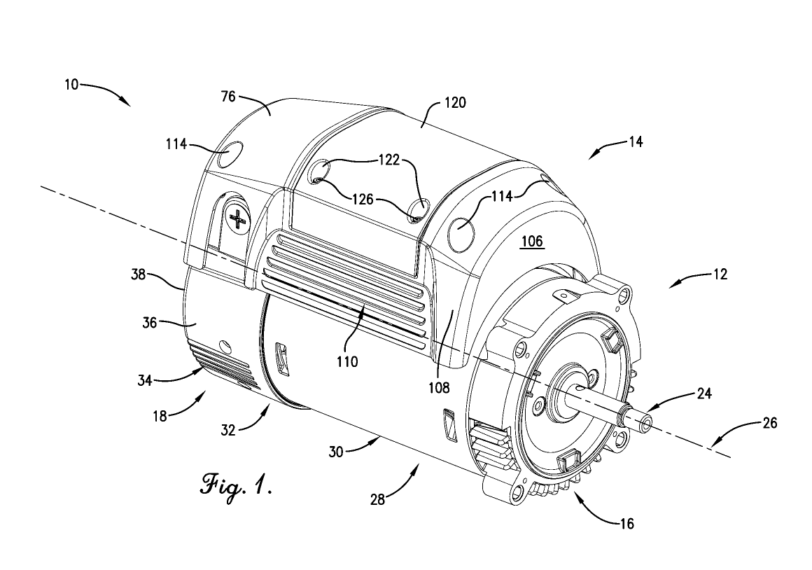

With initial reference to FIGS. 1 & 2, a motor assembly 10 constructed in accordance with the principles of an embodiment of the present invention is depicted for use in various applications. The illustrated motor assembly 10 preferably comprises a horizontally oriented electric motor 12 having an integrated conduit and interface box 14. The conduit and interface box 14 is located on top of the motor 12 to house a power terminal and a user interface, the latter of which is used to variably control the flow of power to the motor 12 and, in turn, variably control the speed of the motor 12. Although the illustrated motor 12 is shown in a horizontal orientation, those of ordinary skill in the art will appreciate that the principles of the present invention are equally applicable to alternative motor orientations (e.g., vertical). It is only necessary for the box 14 to be on the side of the motor 12, as will be described.

While the motor assembly 10 is useful in various applications, the illustrated embodiment has particular utility when the motor assembly 10 is configured to provide variable power and speed to air moving products and pump applications.

The illustrated motor assembly 10 presents a first end, generally known in the art as the shaft end 16, and a second end 18 opposite the shaft end 16. The motor assembly 10 broadly includes an electric motor comprised of dynamoelectric components including a stator 20 and a rotor 22. The rotor 22, which includes a rotor shaft 24, is located generally within the stator 20 and is rotatable relative thereto about an axis 26. As is customary, the dynamoelectric components are suitably powered to impart rotational movement to the rotor shaft 24. In the illustrated embodiment, power to the stator 20 is controlled so to generate the necessary electromagnetic fields for causing rotation of the rotor shaft 24, although other suitable motor configurations are within the ambit of the present invention.

The dynamoelectric components are substantially encased by a motor case 28 that is fixed relative to the stator 20. The motor case 28 preferably includes a generally cylindrical shell 30 and is radially spaced about the rotor axis 26. The preferred motor case 28 further includes a controller housing 32 preferably secured to the shell 30 by an endbell 33. More particularly, in the preferred embodiment, the endbell 33 is fixed to the shell 30 and a plurality of fasteners 35 serve to secure the housing 32 to the endbell 33. The controller housing 32 preferably has a cross-sectional shape and size that at least substantially matches that of the shell 30, such that the housing 32 essentially serves as an extension of the shell 30. The controller housing 32 includes a controller can 34 having a generally cylindrical sidewall 36 and an end wall 38 spaced from the second end 18 of the motor case 28. The controller housing 32 defines a controller compartment 40, for purposes which will be described. The controller can 34 presents a connection block opening 42 that is in direct communication with the controller compartment 40. In a preferred embodiment, the connection block opening 42 is defined by a removable and customizable component that is slidably engaged to a receiving port 44 on the controller can 34. The customizable connection block opening may allow for conduit and interface boxes of various configurations to properly engage with the connection block opening 42 of the controller can 34.

The integrated conduit and interface box 14 is positioned at least substantially radially outside the motor case 28. In a preferred embodiment, the box 14 is located entirely outside the case 28, with the box 14 being secured to the shell 30, as will be described. The box 14 is preferably comprised of a metal material (e.g., die cast aluminum) and is removably fixed to the motor case 28 to form part of the motor assembly 10. The box 14 may house various components of the motor assembly 10, all of which will be described herein.

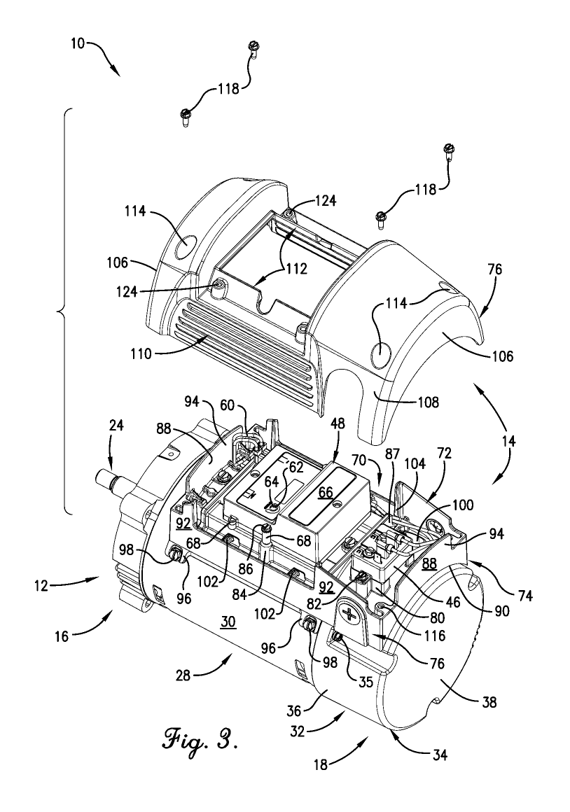

Turning now to FIGS. 3 & 4, the box 14 of the illustrated embodiment houses a high voltage power terminal 46 operable to receive and deliver power to various components of the motor assembly 10, and a user interface 48 for sending and receiving instructions to a motor controller 50 operably connected to the motor 12. In a preferred embodiment, the power terminal 46 and user interface 48 are removably secured to the box 14, as will be described further herein.

The power terminal 46 is connectable to an input power conduit 52. The input power conduit 52 may be configured anywhere on or around the integrated conduit and interface box 14 such that a power source (not shown) for powering the motor assembly is in communication with the motor assembly 10 through connection with the power terminal 46. Also within the integrated conduit and interface box 14 is a ground terminal 54 used for providing an electrical ground to various components of the motor assembly 10. Various power terminals are well-known in the art and may be used within the scope of the invention. The power terminal 46 and ground terminal 54 are at least connectable to the user interface 48 and a motor controller 50, and are further operable to provide power thereto.

A first set of controller wiring 56 connecting the power and ground terminals 46,54 extends through the box 14 and connects to the motor controller 50 configured to operably power the dynamoelectric components of the motor 12. A second set of controller wiring 58 also extends through the box 14 and connects the controller 50 to the user interface 48, as will be described. The controller 50 is securedly housed within the controller compartment 40. Various motor controllers may be used and are well-known in the art, therefore will not be discussed in further detail herein.

A set of interface wiring 60 extends along the interior of the box 14 and connects the power terminal 46 to the user interface 48 for providing power thereto. The user interface 48 is configured to permit an operator to selectively vary a motor condition (e.g., motor speed, voltage, current, power, resistance, etc.). In a preferred embodiment, the user interface 48 includes a potentiometer 62 for selectively varying the motor condition through the transmission of signals to and from the controller 50. The potentiometer 62 may be adjusted using an analog dial 64 or a digital controller input device. Even further, the user interface 48 may include a digital display 66 for providing the operator visual feedback of the motor condition.

In some embodiments, the user interface 48 may be a computing device that comprises a memory element (not shown), the display 66, and/or the input device 64. The computing device may comprise any number and combination of processors, controllers, integrated circuits, programmable logic device, or other data and signal processing devices for carrying out the functions described herein. In embodiments of the invention, the computing device may implement a computer program and/or code segments of the computer program to perform some of the functions described herein. The computer program may be stored on a computer-readable medium residing on or accessible by the user interface 48 for instructing the user interface 48 to operate certain steps of the present invention as described herein. The user interface 48 may further include one or more fastener receiving holes 68, for purposes which will be described.

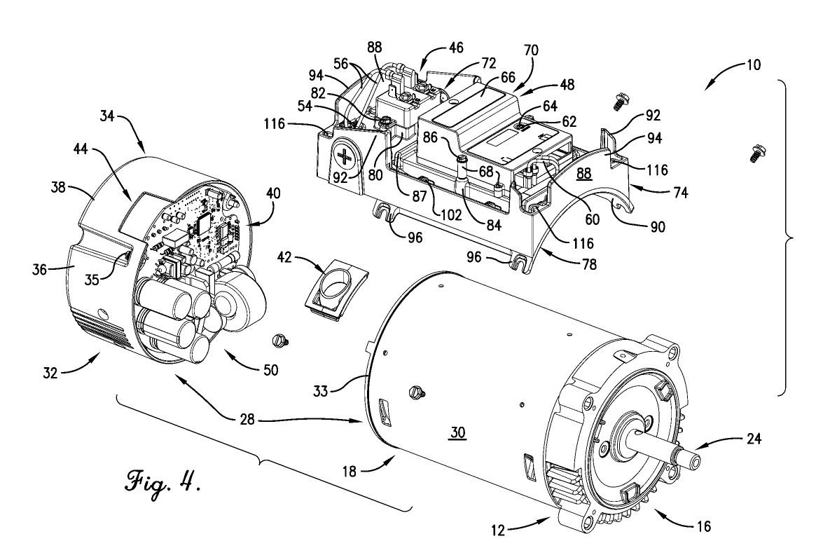

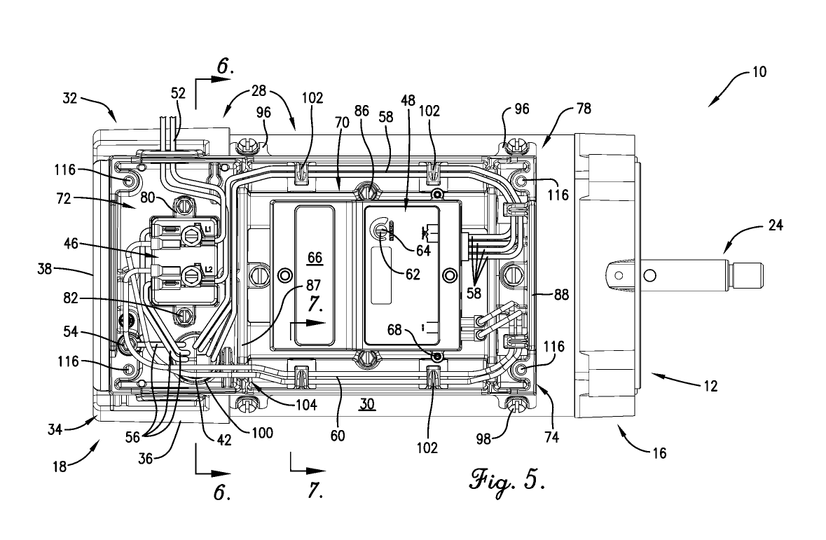

Looking now at FIGS. 3-5, the box 14 generally defines two compartments, including an electronics compartment 70 and a power compartment 72. In the preferred embodiment, the box includes a box frame 74 and a box cover 76 that cooperatively define the compartments 70,72. More preferably, the power compartment 72 is located adjacent the second motor end 18, while the electronics compartment is 72 located adjacent the shaft end 16, although this arrangement may be varied (e.g., reversed) without departing from the spirit of the present invention. It is important, however, for the compartments 70,72 to be separate from one another.

The frame 74 preferably includes a perimetrical base wall 78. The preferred frame 74 presents a power terminal stand 80 to which the power terminal 46 is secured with one or more fasteners 82. The frame 74 preferably also presents an interface support 84 to which the user interface 48 is secured with one or more fasteners 86. The frame 74 may also include a wall structure 87 for facilitating separation of the power compartment 72 and electronics compartment 70.

The frame 74 includes end walls 88 with a curved underside 90 to accommodate the arcuate surface of the motor case 28. Base wall projections 92 extend outwardly from each side of the base wall 78 to support the cover 76. Moreover, the end walls 88 include end wall projections 94 with curved tops to further support the cover 76. The illustrated frame 74 includes a plurality of connection tabs 96 which rest against the outside of the motor shell 30, such that the frame 74 is located entirely outside the motor case 28. It will be appreciated, however, according to certain aspects of the present invention, the box 14 (e.g., the frame 74) may alternatively be configured to project into the case 28 for attachment to one or more internal motor components. Returning to the illustrated embodiment, fasteners 98 project through respective connection tabs 96 and threadably engage the motor shell 30 to securely fasten the frame 74 to the case 28.

The frame 74 also presents a wiring opening 100 in direct communication with the power compartment 72. The wiring opening 100 and connection block opening 42 are substantially aligned so as to directly intercommunicate the power compartment 72 and the controller compartment 40. Although the illustrated embodiments show the power compartment 72 having the wiring opening 100, it is well within the scope of the invention to assume that either the power compartment 72, the electronics compartment 70, or both compartments may be in direct communication with the controller compartment 40. It is also within the scope of the invention to swap the location of the compartments 70,72 such that the electronics compartment 70 presents a wiring opening in direct communication with the controller compartment 40.

As discussed, wiring 58,60 may extend along the frame 74 in various configurations between the power terminal 80, the controller 50, and the user interface 48. The integrated conduit and interface box 14 may include a wire routing structure for retaining the wiring along a path between the power compartment 72 and the electronics compartment 70. In a preferred embodiment, the wire routing structure includes a plurality of spaced apart tabs 102 in retaining engagement with the wiring 58,60. The tabs 102 are generally positioned between the wiring 58,60 and the cover 76 so that the wiring 58,60 is spaced from the cover 76. Various methods of wire retention are well known and may be considered while remaining within the scope of the invention. Moreover, the wall 87 positioned between the power compartment 72 and electronics compartment 70 may include a wiring recess 104 so that the wiring 58,60 may extend through the recess with no concern of unintentional engagement with the cover 76. Other methods of facilitating the passage of wiring between the compartments 70,72 are within the scope of the invention (e.g., a sealed gasket positioned within an opening of the wall 87).

The frame 74 is substantially encased by the cover 76. Furthermore, the preferred cover 76 cooperates with the frame 74 to define the power compartment 72 and the electronics compartment 70. In the illustrated embodiment, the cover 76 includes a pair of end walls 106 and a pair of side walls 108. If desired, the side walls 108 may be provided with slotted openings 110 (as illustrated). The side walls 108 also define interior wall structure, which preferably includes opposed interior panels 112 defining axial extremities of the electronics compartment 70 and at least part of the wall panel 87 that separates the compartments 70,72. Again, when the cover 76 is secured to the frame 74, the cover 76 and frame 74 cooperatively define the power compartment 72 and electronics compartment 70.

In the preferred embodiment, the cover 76 is removably attached to the frame 74. More particularly, the cover 76 includes one or more fastener receiving holes 114 that correspond to one or more fastener receiving holes 116 on the frame 74. Each set of aligned fastener receiving holes 114,116 is configured to a fasteners 118 for removably securing the cover 76 to the frame 74, thereby forming the integrated conduit and interface box 14.

In the preferred embodiment, the user interface 48 is accessible via an interface lid 120. Specifically, the lid 120 is removably attached to the cover 76 in a covering relationship with the user interface 48 housed within the electronics compartment 70. When the lid 120 is removed, the interface 48 is exposed but the power compartment 72 remains substantially covered by the cover 76. The lid 120 and cover 76 include a plurality of corresponding fastener receiving holes 122,124 such that a plurality of fasteners 126 selectively secure the lid 120 to the cover 76. Preferably, removable the lid 120 provides selective access to the user interface 48. Moreover, with the compartments 70,72 separated, high voltage components such as the input power source and power terminal 46 are not readily accessible to the operator when the motor condition (e.g., speed) is selectively varied.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention set forth in the following claims.

What is claimed is:

1. A motor assembly comprising:
dynamoelectric components including a stator and a rotor,
said rotor being located generally within the stator and rotatable relative thereto about a rotor axis;
a motor case fixed relative to the stator,
said motor case being spaced radially about the rotor axis;
a power terminal connectable to an input power conduit;
a user interface operable to permit a user to selectively vary a motor condition; and
an integrated conduit and interface box,
said box being positioned at least substantially radially outside the motor case,
said box including a power compartment in which the power terminal is located,
said box including an electronics compartment in which the user interface is located,
said compartments being separated and axially spaced from one another.

2. The motor assembly as claimed in claim 1,
said box including an interface lid that is removable from a covering relationship with the user interface,
said box being configured so that the power compartment remains at least substantially covered when the interface lid is removed.

3. The motor assembly as claimed in claim 1,
said box including a cover that at least partly defines the power compartment and the electronics compartment,
said cover including wall structure separating the power compartment from the electronics compartment.

4. The motor assembly as claimed in claim 3,
said box including a frame secured to the motor case, with the power terminal and interface being secured to the frame,
said frame and cover cooperatively defining the power compartment and electronics compartment.

5. The motor assembly as claimed in claim 4,
said cover including an interface lid that is removable from a covering relationship with the user interface,
said cover being configured so that the power compartment remains at least substantially covered when the interface lid is removed.

6. The motor assembly as claimed in claim 4,
said motor case including a generally cylindrical shell fixed about the stator,
said frame including a concave, arcuate case interface configured to receive a portion of the shell.

7. The motor assembly as claimed in claim 6,
said shell presenting an outer shell surface,
said box including a plurality of connection tabs in engagement with the outer shell surface,
said box including a plurality of fasteners that secure respective connection tabs to the outer shell surface.

8. The motor assembly as claimed in claim 1,
said motor case including a motor controller housing; and
a motor controller configured to operably power the dynamoelectric components,
said controller housing defining a controller compartment in which the motor controller is housed.

9. The motor assembly as claimed in claim 8,
said motor condition being the rotational speed of the rotor,
said user interface including a potentiometer operably coupled to the motor controller.

10. The motor assembly as claimed in claim 8,
said motor case including a generally cylindrical shell fixed about the stator,
said shell presenting opposite ends,
said motor controller housing including a controller can positioned adjacent a first one of the ends of the shell,
said controller can including a generally cylindrical sidewall and an end wall spaced from the first one of the ends of the shell.

11. The motor assembly as claimed in claim 10,
said shell and said sidewall having substantially equal cross-sectional dimensions.

12. The motor assembly as claimed in claim 10,
said box presenting a wiring opening in direct communication with the power compartment,
said controller can presenting connection block opening in direct communication with the controller compartment,
said wiring opening and connection block opening being aligned so as to directly intercommunicate the power compartment and the controller compartment.

13. The motor assembly as claimed in claim 10,
said rotor presenting a rotor shaft which projects from only a second one of the ends of the motor case,
said first and second ends being opposite one another.

14. The motor assembly as claimed in claim 1,
said motor case presenting a connection block opening in direct communication with an interior of the motor case,
said box presenting a wiring opening in direct communication with at least one of the power and electronics compartments,
said wiring opening and connection block opening being aligned so as to directly intercommunicate the interior of the motor case and the at least one of the power and electronics compartments.

15. The motor assembly as claimed in claim 1; and
low voltage wiring extending between the power terminal and the user interface,
said box including wire routing structure which retains the wiring along a path between the power compartment and the electronics compartment.

16. The motor assembly as claimed in claim 15,
said box including a frame secured to the motor case, with the power terminal and interface being secured to the frame,
said wire routing structure including a plurality of spaced apart tabs in retaining engagement with the wiring.

17. The motor assembly as claimed in claim 16,
said box including a cover that at least partly defines the power compartment and the electronics compartment,
said cover being connected to the frame,
said tabs being positioned between the wiring and cover so as to space the wiring from the cover.

18. The motor assembly as claimed in claim 17,
said frame including a wall positioned between the power compartment and electronics compartment,
said wall including a wiring recess, with the wiring extending through the recess.

19. The motor assembly as claimed in claim 1,
said rotor axis being substantially horizontal,
said box being located on the top of the motor case.
